(19) United States
(12) Patent Application Publication
(10) Pub. No.: US 2011/0116287 A1
(43) Pub. Date: May 19, 2011

(54) SWITCHING CONTROLLER HAVING SWITCHING FREQUENCY HOPPING FOR POWER CONVERTER

(75) Inventors: Wei-Hsuan Huang, Taoyuan County (TW); Jenn-Yu G. Lin, Taipei Hsien (TW); Ta-Yung Yang, Milpitas, CA (US)

(73) Assignee: SYSTEM GENERAL CORP., Taipei Hsien (TW)

(21) Appl. No.: 13/012,800

(22) Filed: Jan. 25, 2011

Related U.S. Application Data
(63) Continuation-in-part of application No. 12/276,415, filed on Nov. 24, 2008, now Pat. No. 7,903,435.
(60) Provisional application No. 61/188,060, filed on Aug. 5, 2008.

(51) Int. Cl. H02M 3/335

(52) U.S. Cl. 363/21.13

(57) ABSTRACT

A switching controller having switching frequency hopping for a power converter includes an oscillator generating a pulse signal for determining a switching frequency of a switching signal, a maximum duty-cycle circuit generating a maximum duty-cycle signal in response to the switching signal for determining the switching frequency of the switching signal, a pattern generator generating a digital pattern code in response to a clock signal, a programmable capacitor coupled to the pattern generator and the oscillator for modulating the switching frequency of the switching signal in response to the digital pattern code, and a PWM circuit coupled to the oscillator and the maximum duty-cycle circuit for generating the switching signal in accordance with the pulse signal and the maximum duty-cycle signal. A maximum on-time of the switching signal is limited by the maximum duty-cycle signal. The switching signal is utilized to switch a transformer of the power converter.

### CROSS-REFERENCE TO RELATED APPLICATION

This is a continuation-in-part application of and claims the priority benefit of patent application Ser. No. 12/276,415, filed on Nov. 24, 2008, which claims the priority benefit of U.S. provisional application Ser. No. 61/188,060, filed on Aug. 5, 2008. The entirety of each of the above-mentioned patent applications is hereby incorporated by reference herein and made a part of this specification.

### BACKGROUND OF THE INVENTION

1. Field of the Invention

The present invention relates to a power converter in a switching mode, and more specifically relates to a switching controller with switching frequency hopping.

2. Description of Related Art

Power converters have been used to convert an AC power source to a regulated voltage or current. The power converters need to maintain an output voltage, output a current, or output power within a regulated range for efficient and safe operation of an electronic device. A problem of utilizing pulse width modulation is that the power converters operate at a relatively high frequency compared to the frequency of the AC power source, which results in a high frequency signal generated by the power converters. Although the switching technique reduces the size of the power supply, switching devices generate electric and magnetic interference (EMI) which interferes with the power source. Generally, an EMI filter disposed at an input of the power supply is utilized to reduce the EMI. However, the EMI filter causes power consumption and increases the cost and the size of the power supply. In recent development, it has been proposed in related art to reduce the EMI by using frequency modulation or frequency hopping, e.g., in “Effects of Switching Frequency Modulation on EMI Performance of a Converter Using Spread Spectrum Approach” by M. Rahkala, T. Suntio, K. Kalliomaki, APEC 2002 (Applied Power Electronics Conference and Exposition, 2002), 17-Annual, IEEE, Volume 1, 10-14, March, 2002.

### SUMMARY OF THE INVENTION

The present invention provides a switching controller having switching frequency hopping to reduce the EMI for a power converter. The switching controller includes a first oscillator to generate a pulse signal and a maximum duty-cycle signal for determining a switching frequency of a switching signal. A maximum duty-cycle circuit generates a maximum duty-cycle signal in response to the switching signal for determining the switching frequency of the switching signal. A pattern generator with a second oscillator generates a digital pattern code in response to a clock signal, wherein the clock signal is generated by the second oscillator. A programmable capacitor is coupled to the pattern generator and the first oscillator for modulating the switching frequency of the switching signal in response to the digital pattern code. A pulse width modulation (PWM) circuit is coupled to the first oscillator and the maximum duty-cycle circuit for generating the switching signal in accordance with the pulse signal and the maximum duty-cycle signal. A maximum on-time of the switching signal is limited by the maximum duty-cycle signal. Thus, the EMI can be improved and the EMI filter is not required.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a power supply having a switching controller according to a first embodiment of the present invention.

FIG. 2 shows a frequency modulator having frequency hopping according to the first embodiment of the present invention.

FIG. 3 shows a pattern generator according to the first embodiment of the present invention.

FIG. 4 shows waveforms of an oscillation signal, a pulse signal, an inverse pulse signal, a maximum duty-cycle signal, a current signal and a switching signal according to the first embodiment of the present invention.

FIG. 5 shows a power supply having a switching controller according to a second embodiment of the present invention.

FIG. 6 shows a frequency modulator having frequency hopping according to the second embodiment of the present invention.

FIG. 7 shows waveforms of the pulse signal, the switching signal, a reference voltage, a storage voltage, and the maximum duty-cycle signal according to the second embodiment of the present invention.

### DESCRIPTION OF THE EMBODIMENTS

### First Embodiment

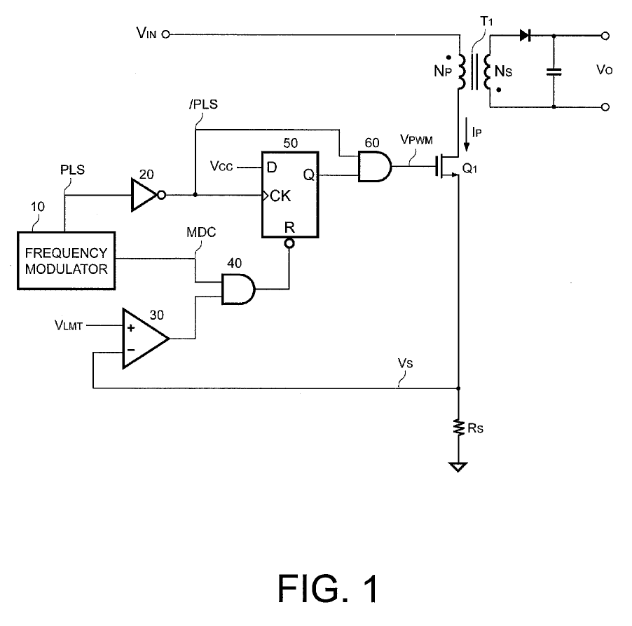

FIG. 1 shows a power supply having a switching controller according to a first embodiment of the present invention. The switching controller includes a PWM circuit and a frequency modulator 10. The switching controller generates a switching signal V_{PWM} for switching a transformer T₁ via a power transistor Q₁. The transformer T₁ receives input voltage Vin and generates an output voltage Vo having a primary side Np and a secondary side Ns. The duty cycle of the switching signal V_{PWM} determines the power supplied by an AC power source to an output of the power supply. The PWM circuit comprises an inverter 20, a comparator 30, a first AND gate 40, a D flip-flop 50, and a second AND gate 60. A switching current I_{P} of the transformer T₁ is converted to a current signal V_{S} (in voltage form) through a sense resistor R_{S}. The current signal V_{S} is provided to the PWM circuit for pulse width modulation of the switching signal V_{PWM}. A negative input of the comparator 30 is supplied with the current signal V_{S}. A positive input of the comparator 30 receives a current-limit signal V_{LMT} to limit the maximum output power.

An input D of the D flip-flop 50 is pulled high by a supply voltage V_{CC}. A clock input CK of the D flip-flop 50 is supplied with a pulse signal PLS through the inverter 20. A first input of the first AND gate 40 is coupled to the frequency modulator 10 to receive a maximum duty-cycle signal MDC. A second input of the first AND gate 40 is connected to an output of the comparator 30. An output of the first AND gate 40 is used to reset the D flip-flop 50 once the current signal V_{S} is higher than the current-limit signal V_{LMT} and a maximum duty-cycle signal MDC is at a low level. A first input of the second AND gate 60 is connected to an output of the inverter 20 to receive an inverse pulse signal /PLS. An input of the inverter 20 is connected to the frequency modulator 10 to receive a pulse signal PLS. A second input of the second AND gate 60 is connected to an output Q of the D flip-flop 50. An output of the second AND gate 60 is connected to the power transistor Q₁ to generate the switching signal V_{PWM}.

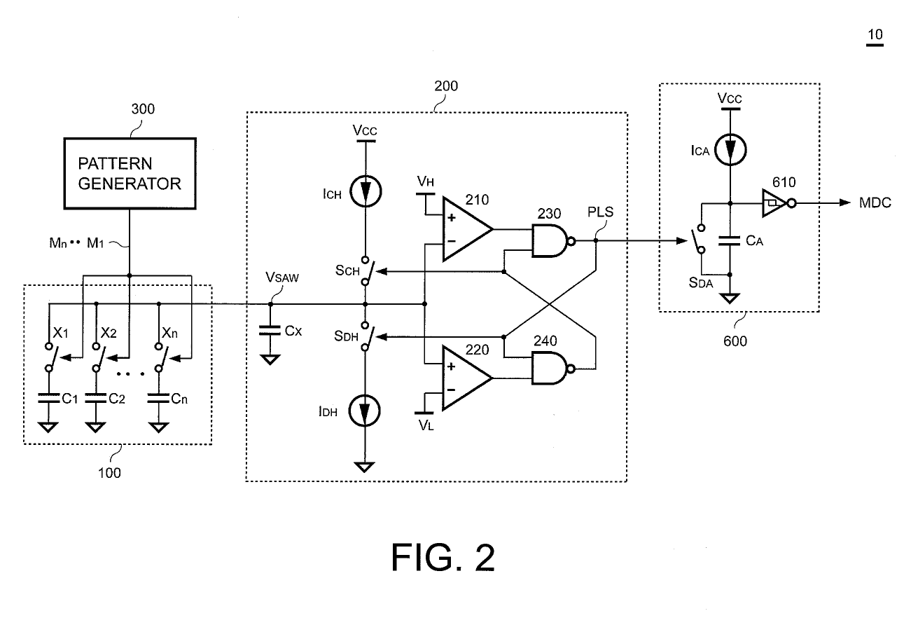

FIG. 2 shows a frequency modulator according to the first embodiment of the present invention. In FIG. 2, the frequency modulator 10 includes a pattern generator 300, a programmable capacitor 100, and a first oscillator 200 with a maximum duty-cycle circuit 600. The pattern generator 300 is utilized to generate digital pattern codes Mn . . . M₁. The programmable capacitor 100 receives the digital pattern codes Mn . . . M₁ of the pattern generator 300 for generating an oscillation signal V_{SAW}. The first oscillator 200 is coupled to the programmable capacitor 100 for generating the pulse signal PLS in response to the oscillation signal V_{SAW}. The maximum duty-cycle circuit 600 generates the maximum duty-cycle signal MDC in response to the pulse signal PLS.

The programmable capacitor 100 is coupled to the pattern generator 300 to receive the digital pattern codes Mn . . . M₁. The programmable capacitor 100 comprises a plurality of switching-capacitor sets connected to one another in parallel. The switching-capacitor sets are formed by capacitors C₁, C₂, . . . , Cn and switches X₁, X₂, . . . , Xn. The switch X₁ and the capacitor C₁ are connected in series. The switch X₂ and the capacitor C₂ are connected in series. The switch Xn and the capacitor Cn are connected in series. The digital pattern codes Mn . . . M₁ control switches X₁, X₂, . . . , Xn. An output of the programmable capacitor 100 is coupled to the first oscillator 200 for modulating the oscillation signal V_{SAW} in accordance with the digital pattern codes Mn . . . M₁.

The first oscillator 200 includes a charging switch S_{CH}, a discharging switch S_{DH}, a saw-tooth capacitor C_{X}, a charging current I_{CH}, a discharging current I_{DH}, a first comparator 210, a second comparator 220, and two NAND gates 230 and 240. The charging switch S_{CH} is connected between the charging current I_{CH} and the saw-tooth capacitor C_{X}. The discharging switch S_{DH} is connected between the saw-tooth capacitor C_{X} and the discharging current I_{DH}. The oscillation signal V_{SAW} at the saw-tooth capacitor C_{X} is coupled to the output of the programmable capacitor 100. The first comparator 210 has a positive input supplied with a threshold voltage V_{H}. A negative input of the first comparator 210 is connected to the saw-tooth capacitor C_{X}. The second comparator 220 has a negative input supplied with a threshold voltage V_{L}. The threshold voltage V_{H} is higher than the threshold voltage V_{L}. A positive input of the second comparator 220 is connected to the saw-tooth capacitor C_{X}. An output of the NAND gate 230 generates the pulse signal PLS to turn on/off the discharging switch S_{DH}. A first input of the NAND gate 230 is driven by an output of the first comparator 210. Two inputs of the NAND gate 240 are respectively connected to the output of the NAND gate 230 and an output of the second comparator 220. The output of the NAND gate 240 is connected to a second input of the NAND gate 230 and turns on/off the charging switch S_{CH}. The first oscillator 200 is coupled to the programmable capacitor 100 for generating the pulse signal PLS in response to the oscillation signal V_{SAW} at the saw-tooth capacitor C_{X}.

When the charging switch S_{CH} is turned on, the charging current I_{CH} charges the saw-tooth capacitor C_{X}, and the oscillation signal. V_{SAW} increases. During this period, the oscillation signal V_{SAW} is lower than the threshold voltage V_{H}, and the discharging switch S_{DH} is turned off. The discharging current I_{DH} discharges the saw-tooth capacitor C_{X}, and the oscillation signal V_{SAW} decreases when the oscillation signal V_{SAW} is over than the threshold voltage V_{H}. At this time, the charging switch S_{CH} is turned off and the discharging switch S_{DH} is turned on. The charging switch turns on again when the oscillation signal V_{SAW} is lower than the threshold voltage V_{L}. The switching period of the oscillation signal V_{SAW} is controlled by the capacitance of the saw-tooth capacitor C_{X} connected to the switching-capacitor sets in parallel. The switches X₁, X₂, . . . , Xn are controlled by the digital pattern codes Mn . . . M₁ to determine the quantity of the switching-capacitor sets.

The maximum duty-cycle circuit 600 includes a switch S_{DA}, a charging current I_{CA}, a capacitor C_{A}, and a first trigger 610. The switch S_{DA} is connected to the charging current I_{CA} and connected to the capacitor C_{A} in parallel. The switch S_{DA} is controlled by the pulse signal PLS. The capacitor C_{A} is charged by the charging current I_{CA} once the switch S_{DA} is turned off. In other words, the capacitor C_{A} is discharged when the switch S_{DA} is turned on. An input of the first trigger 610 is coupled to the switch S_{DA}, the charging current I_{CA}, and the capacitor C_{A}. The first trigger 610 can serve as a Schmitt trigger circuit. An output of the first trigger 610 generates the maximum-duty-cycle signal MDC in response to the pulse signal PLS of the first oscillator 200. The pulse width of the maximum duty-cycle signal MDC is determined by the charging current I_{CA} and the capacitor C_{A}. Furthermore, the maximum on-time of the switching signal V_{PWM} is determined by the maximum duty-cycle signal MDC.

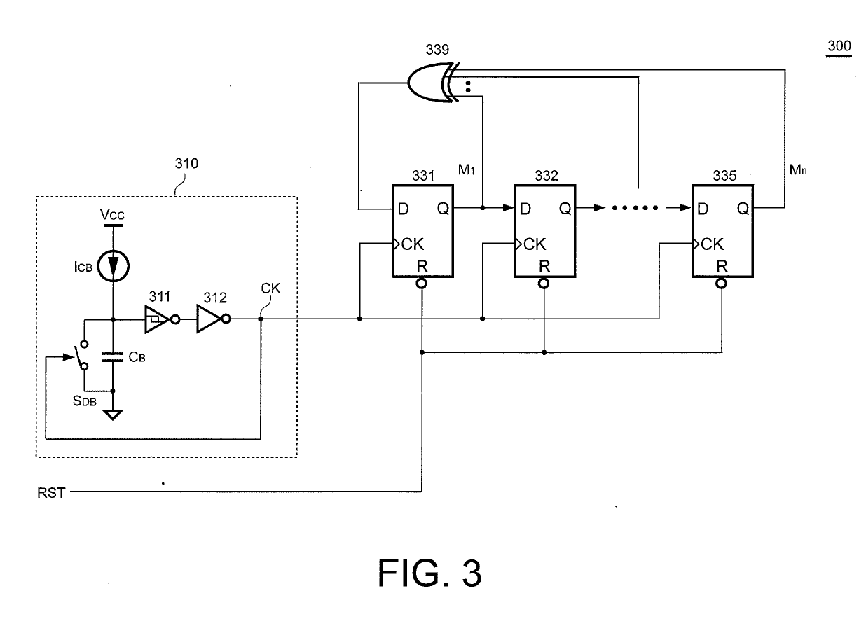

FIG. 3 shows the pattern generator 300 according to the first embodiment of the present invention. The pattern generator 300 includes a second oscillator 310, a plurality of registers 331, 332, . . . , 335, and a XOR gate 339. The registers 331, 332 , . . . , 335 and the XOR gate 339 develop a linear feedback shift register (LFSR) for generating a linear code in response to a clock signal CK of the second oscillator 310. The inputs of the XOR gate 339 determine the polynomials of the linear feedback shift register and decide the output of the linear feedback shift register. Furthermore, the digital pattern codes Mn . . . M₁ can be adopted from the part of the linear code to optimize the application.

The second oscillator 310 includes a switch S_{DB}, a charging current I_{CB}, a capacitor C_{B}, a second trigger 311, and an inverter 312. The switch S_{DB} is coupled to the charging current I_{CB} and connected to the capacitor C_{B} in parallel. The switch S_{DB} is controlled by the clock signal CK. The capacitor C_{B} is charged by the charging current I_{CB} once the switch S_{DB} is turned off. In other words, the capacitor C_{B} is discharged when the switch S_{DB} is turned on. An input of the second trigger 311 is coupled to the switch S_{DB}, the charging current I_{CB}, and the capacitor C_{B}. The second trigger 311 can also serve as the Schmitt trigger circuit. An output of the second trigger 311 is coupled to an input of the inverter 312. An output of the inverter 312 generates the clock signal CK.

The second oscillator 310 generates the clock signal CK. The pattern generator 300 is utilized to generate the digital pattern codes Mn . . . M₁ in response to the clock signal CK of the second oscillator 310. The first oscillator 200 is used for determining a pulse width of the pulse signal PLS and a switching frequency of the switching signal V_{PWM}. As mentioned above, the pulse signal PLS and the clock signal CK are asynchronous because both of them are generated by two different oscillators. Therefore, the switching signal V_{PWM} is independent of the clock signal CK. The programmable capacitor 100 is coupled to the pattern generator 300 and the first oscillator 200 for modulating the switching frequency of the switching signal V_{PWM} in response to the digital pattern codes Mn . . . M₁.

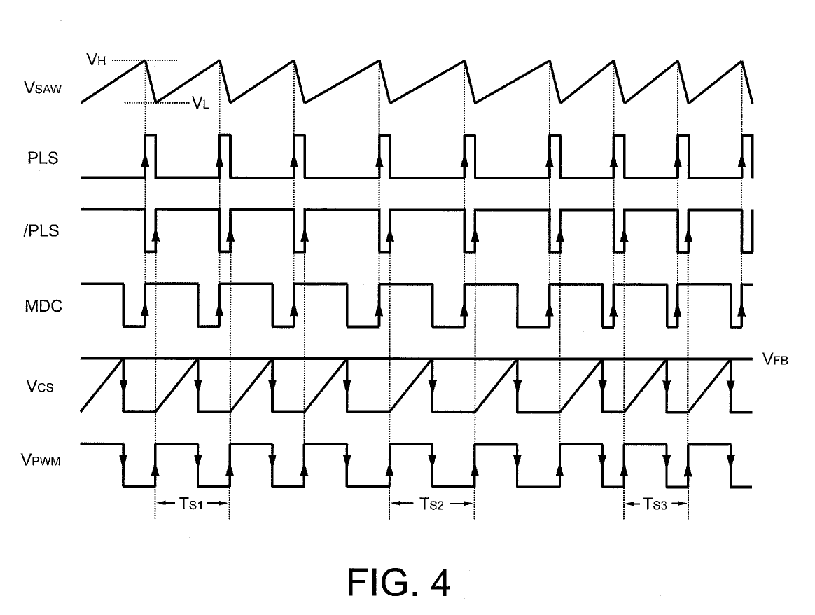

FIG. 4 shows waveforms of the oscillation signal V_{SAW}, the pulse signal PLS, the inverse pulse signal /PLS, the maximum-duty-cycle signal MDC, the current signal V_{S}, and the switching signal V_{PWM} according to the first embodiment of the present invention. The digital pattern codes Mn . . . M₁ control the switching-capacitor sets to connect the saw-tooth capacitor C_{X} in parallel for modulating the oscillation signal V_{SAW}. The different capacitances of the saw-tooth capacitor C_{X} cycle-by-cycle generate the frequency variation of the switching signal V_{PWM}. The switching periods T_{S1}, T_{S2}, and T_{S3} represent the switching frequency hopping for the switching signal V_{PWM}, respectively. The maximum duty-cycle signal MDC is utilized to limit the maximum on-time of the switching signal V_{PWM}.

### Second Embodiment

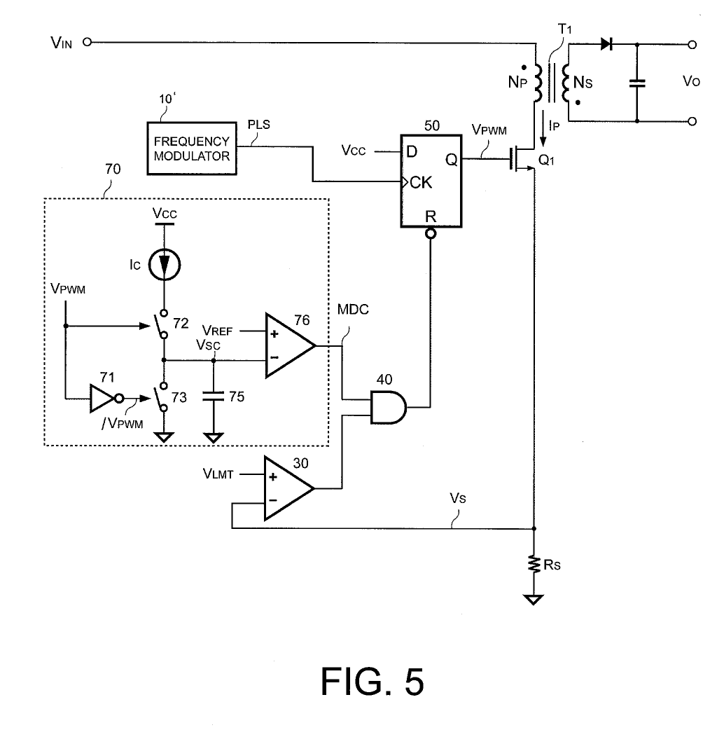

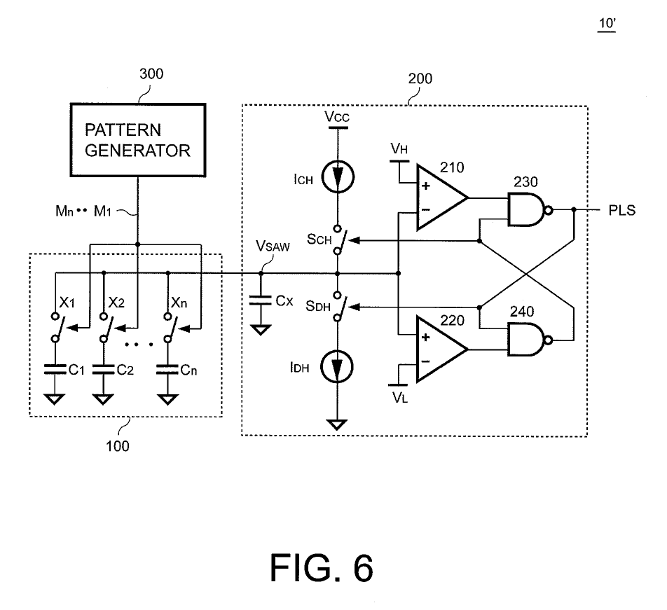

FIG. 5 shows a power supply having a switching controller according to a second embodiment of the present invention. FIG. 6 shows a frequency modulator having frequency hopping according to the second embodiment of the present invention. Referring to FIG. 5 and FIG. 6, the design concept of the switching controller of the second embodiment is similar to that of the first embodiment, and the difference therebetween is described as follows.

The switching controller of the second embodiment includes a PWM circuit, a frequency modulator 10′, and a maximum duty-cycle circuit 70 as shown in FIG. 5. The PWM circuit generates the switching signal V_{PWM} in accordance with the pulse signal PLS and the maximum duty-cycle signal MDC. For design purpose, some elements such as the inverter 20 and the second AND gate 60 in FIG. 1 are omitted to simplify the architecture of the PWM circuit in the present embodiment. However, the operation of the PWM circuit of the second embodiment is similar to that of the first embodiment, and it will not be described again herein.

On the other hand, compared with the frequency modulator 10, the frequency modulator 10′ includes the pattern generator 300, the programmable capacitor 100, and the first oscillator 200 except for the maximum duty-cycle circuit 600 as shown in FIG. 6. For generating the pulse signal PLS, the operation of the frequency modulator 10′ is similar to that of the frequency modulator 10, and it will not be described again herein.

It should be noted that, the maximum duty-cycle circuit 70 generates the maximum duty-cycle signal MDC in response to the switching signal V_{PWM} in the present embodiment.

Specifically, the maximum duty-cycle circuit 70 includes a comparator 76, a capacitor 75, a charging current I_{C}, switches 72 and 73, and an inverter 71. Herein, the charging current I_{C} and the switches 72 and 73 are connected in series, and the switch 73 and the capacitor 75 are connected in parallel as shown in FIG. 5. The switches 72 and 73 are respectively controlled by the switching signal V_{PWM} and an inverse switching signal /V_{PWM} which is produced by inverting the switching signal V_{PWM} through the inverter 71. The capacitor 75 is charged by the charging current I_{C} when the switch 72 is turned on by the switching signal V_{PWM}, and the capacitor 75 is discharged when the switch 73 is turned on by the inverse switching signal /V_{PWM}.

On the other hand, a positive input of the comparator 76 is coupled to a reference voltage V_{REF}, a negative input of the comparator 76 is coupled to the capacitor 75, and an output of the comparator 76 outputs the maximum duty-cycle signal MDC to the PWM circuit. According to comparing a storage voltage V_{SC} of the capacitor 75 with the reference voltage V_{REF}, the comparator 76 outputs the maximum duty-cycle signal MDC with a low level once the storage voltage V_{SC} is higher than the reference voltage V_{REF}, and the comparator 76 outputs the maximum duty-cycle signal MDC with a high level when the storage voltage V_{SC} is lower than the reference voltage V_{REF}.

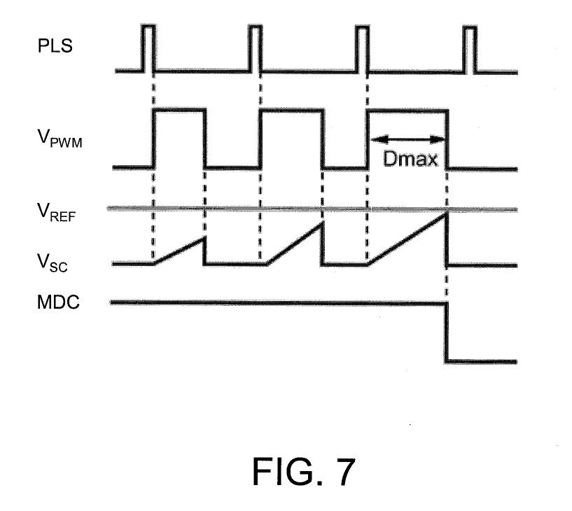

FIG. 7 shows waveforms of the pulse signal PLS, the switching signal V_{PWM}, the reference voltage V_{REF}, the storage voltage V_{SC}, and the maximum duty-cycle signal MDC according to the second embodiment of the present invention. Referring to FIG. 5 and FIG. 7, the switching signal V_{PWM} controls the switches 72 and 73, and the reference voltage V_{REF} and the storage voltage V_{SC} are respectively received by the positive input and the negative input of the comparator 76. When the switch 73 is turned on by the inverse switching signal /V_{PWM}, the capacitor 75 is discharged. By contrast, when the switch 72 is turned on by the switching signal V_{PWM}, the capacitor 75 is charged. During the period when the storage voltage V_{SC} is lower than the reference voltage V_{REF}, the comparator 76 outputs the maximum duty-cycle signal MDC with the high level as shown FIG. 7.

However, when the switching signal V_{PWM} is at high level and the switch 72 is turned on, the capacitor 75 is charged by the charging current I_{C} and the storage voltage V_{SC} is gradually increased. Once the storage voltage V_{SC} is higher than the reference voltage V_{REF}, the comparator 76 outputs the maximum duty-cycle signal MDC with the low level, and accordingly, the output of the first AND gate 40 resets the D flip-flop 50 to limit the maximum on-time Dmax of the switching signal V_{PWM}. That is to say, the maximum duty-cycle circuit 70 generates the maximum duty-cycle signal MDC in response to the switching signal V_{PWM}, and the maximum duty-cycle signal MDC is utilized to limit the maximum on-time Dmax of the switching signal V_{PWM}.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A switching controller having switching frequency hopping for a power converter, comprising:
a first oscillator, generating a pulse signal for determining a switching frequency of a switching signal;
a maximum duty-cycle circuit, generating a maximum duty-cycle signal in response to the switching signal for determining the switching frequency of the switching signal;
a pattern generator with a second oscillator, generating a digital pattern code in response to a clock signal, wherein the clock signal is generated by the second oscillator;
a programmable capacitor, coupled to the pattern generator and the first oscillator for modulating the switching frequency of the switching signal in response to the digital pattern code; and
a PWM circuit, coupled to the first oscillator and the maximum duty-cycle circuit for generating the switching signal in accordance with the pulse signal and the maximum duty-cycle signal, a maximum on-time of the switching signal being limited by the maximum duty-cycle signal, wherein the switching signal is utilized to switch a transformer of the power converter.

2. The switching controller as claimed in claim 1, wherein a switching period of the pulse signal is correlated to a switching period of the switching signal.

3. The switching controller as claimed in claim 1, wherein a switching period generated by the first oscillator is independent of a switching period generated by the second oscillator.

4. The switching controller as claimed in claim 1, wherein a switching period of the pulse signal is independent of a switching period of the clock signal.

5. The switching controller as claimed in claim 1, wherein the digital pattern code controls switching-capacitor sets to connect a saw-tooth capacitor in parallel for modulating an oscillation signal, and different capacitances of the saw-tooth capacitor cycle-by-cycle generates frequency variation of the switching signal.

6. The switching controller as claimed in claim 1, wherein the programmable capacitor comprises a plurality of switching-capacitor sets connected to one another in parallel, the switching-capacitor sets are formed by several switches and capacitors connected in series respectively, and the switches are controlled by the digital pattern code.

7. The switching controller as claimed in claim 1, wherein the second oscillator comprises:
a first switch, coupled to a first charging current, the first switch being controlled by the clock signal;
a first capacitor, coupled to the first charging current and connected to the first switch in parallel, wherein the first capacitor is charged by the first charging current once the first switch is turned off, and the first capacitor is discharged when the first switch is turned on; and
a trigger and a first inverter, coupled to the first switch, the first charging current, and the first capacitor for generating the clock signal.

8. The switching controller as claimed in claim 1, wherein the maximum duty-cycle circuit comprises:
a comparator, coupled to the PWM circuit for outputting the maximum duty-cycle signal, and a first input of the comparator coupled to a reference voltage; and
a second capacitor, coupled to a second input of the comparator, wherein the comparator outputs the maximum duty-cycle signal with a low level once a storage voltage of the second capacitor is higher than the reference voltage, and the comparator outputs the maximum duty-cycle signal with a high level when the storage voltage of the second capacitor is lower than the reference voltage.

9. The switching controller as claimed in claim 8, wherein the maximum duty-cycle circuit further comprises:
a second charging current, coupled to the second capacitor for charging the second capacitor;
a second switch, coupled to the second charging current, the second switch being controlled by the switching signal, wherein the second capacitor is charged by the second charging current once the second switch is turned on; arid
a third switch, coupled to the second switch and connected to the second capacitor in parallel, the third switch being controlled by an inverse switching signal, wherein the second capacitor is discharged when the third switch is turned on.

10. The switching controller as claimed in claim 9, wherein the maximum duty-cycle circuit further comprises:
a second inverter, coupled to a control input of the third switch for inverting the switching signal and accordingly outputting the inverse switching signal to control the third switch.
